(19) United States
(12) Patent Application Publication
(10) Pub. No.: US 2012/0134529 A1
(43) Pub. Date: May 31, 2012

(54) Method and apparatus for applying of a watermark to a video during download

(76) Inventors: Pedro Javier Vazquez, Prague (CZ); Kucherenko Danylo, Petrozavodsk (RU)

(21) Appl. No.: 13/301,451

(22) Filed: Nov. 21, 2011

Related U.S. Application Data
(60) Provisional application No. 61/417,448, filed on Nov. 28, 2010.

(51) Int. Cl. G06K 9/34

(52) U.S. Cl. 382/100

(57) ABSTRACT

A method and apparatus for applying of a watermark to a video using a computer coupled to a network. Unreferenced frames in the video are identified. The video is parsed into paired sequential segments each having a long-compressed segment usually about 2 minutes long and a short-uncompressed segment usually about 2-10 seconds long and having at least one of the unreferenced frames. When the computer accepts a request to download the video, it generates a watermark comprising a randomly-generated alphanumeric string that is associated with the request. The computer then makes a watermarked-short-uncompressed segment for each paired sequential segment by insertion of the watermark into the unreferenced frame in such segment and then compresses it to create a watermarked-short-compressed segment corresponding to each long-compressed segment. In response to the request for the video, the computer then sends each long-compressed segment seamlessly appended by its corresponding watermarked-short-compressed segment.

### CROSS-REFERENCE TO RELATED APPLICATION

This application claims the benefit of U.S. Provisional Application No. 61/417,448, filed 28 Nov. 2010, which is hereby incorporated by reference herein.

### TECHNICAL FIELD

In the field of image analysis, a method and apparatus for on-the-fly application of a user-specific watermark to a video during download by that user, the method employing image analysis to locate and apply the watermark without delaying the process of downloading the video.

### BACKGROUND ART

Digital watermarking a video file to identify the initial recipient of that particular video is an effective method to used by the video owner to discourage the illicit transfer of the video from an original legitimate recipient to a recipient who has not paid for the video. It is used to address theft of the video file by, for example, peer-to-peer file sharing systems on public networks, which has enabled one person who legally obtains a file to then offer it to others who connect to a network and download the file.

A video, or video file, typically comprises frames. In filmmaking, video production, animation, and related fields, a film frame or video frame is usually one of the many still images which compose the complete moving picture. A frame is also sometimes used as a unit of time, so that a momentary event might be said to last 6 frames. The actual duration of the event depends on the frame rate of the system, which varies according to the video or film standard in use.

In the past, unauthorized copies of videos in the movie industry were hard copies on tape, such as video cassette tapes, or other portable physical media, such as DVD. While these copies remain in use, and can be copied by users with the right equipment, it was not a simple or easy copying process available to all viewers.

However, the ubiquity of high-bandwidth Internet connections has made circumvention of owner's rights a simple matter of a few clicks on computer. More and more movies are delivered today via streaming or simple download. Thus, it is a growing trend that is of presenting concerns for piracy and loss of revenue to video owners.

Internal to the movie industry, an authorized copy of an electronic video file is sometimes illicitly converted to an unauthorized version and a watermark removed by a thief. It has been reported that a large percentage of illegally shared movies are leaked by industry insiders. It has also been reported that the availability of unauthorized copies directly affects theater attendance and DVD sales, and hence represents a major financial threat to the movie industry.

While multimedia segmentation techniques embed watermarks in multimedia signals, such as images, video and audio, these techniques do not add watermarking during download, often require significant computer resources and can delay the availability of the multimedia signals well beyond practical utilization in video sales.

### SUMMARY OF INVENTION

A method and apparatus for applying of a watermark to a video using a computer coupled to a network. The video is an electronic media file organized in frames some of which are referenced by other frames within the video and some which are unreferenced by any other frames in the video. Steps in the method include identifying the unreferenced frames in the video and parsing the video into a plurality of paired sequential segments each having a long-compressed segment usually about 2 minutes long and a short-uncompressed segment usually about 2 to 10 seconds long. Each short-uncompressed segment has at least one of the unreferenced frames. When the computer accepts a request to download the video, it generates a watermark comprising a randomly-generated alphanumeric string that is associated with the request. The computer then makes a watermarked-short-uncompressed segment for each paired sequential segment by insertion of the watermark into the unreferenced frame and then compresses it to create a watermarked-short-compressed segment corresponding to each long-compressed segment. In response to the request for the video, the computer then sends each long-compressed segment seamlessly appended by its corresponding watermarked-short-compressed segment.

The computer may comprise modules for the differing tasks including a video configuration module a segmenting module, a watermark generation module, a watermark processing module, and a streaming module.

### Technical Problem

Watermarking a video file in many locations throughout the movie is a time consuming process that is expensive to perform, requires significant computer resources, and must be done in a way to make it difficult to detect and remove the watermark. Watermarks previously applied to videos are implemented with time consuming processes. Those that minimize computer resources or expensive operations have been easily detectable and removable in the pirating process, which defeats the purpose of the watermark.

For watermarking to be an effective tool to combat piracy of files, the watermark must be small as to be virtually undetectable in all locations, inserted in such a way as to make it impractical to remove the watermark, and associated with a particular user so as to enable tracing the source of an illegal copy of the video.

Previously user-specific watermarks for each copy were so time-consuming as to be impractical for regular use. But a user-specific watermarking method that requires no significant time delay between request and receipt of the copy is needed.

Presently, watermarking methods present problems in the size in bytes required to implement a unique watermark, the time it takes to mark a video file with a mark unique to a particular user, the large amount of computer resources needed and the consequent frustration of sale due to forcing a potential video purchaser to wait for the watermarking process to complete.

### Solution to Problem

The solution is on-the-fly user-specific watermarking during video download. This is enabled by a method and computer that preprocesses a video to create long unmarked and compressed segments and short uncompressed segments ready for marking. When a user requests a video, a long segment begins to immediately download while the computer creates a watermark for the specific user and applies that watermark to the short uncompressed segments and then compresses the watermarked short segment in time to seamlessly append each short segment to each downloading long segment.

### Advantageous Effects of Invention

This system generates unique watermarked videos in real-time. In this system, video data is prepared in such a way that it becomes possible to handle many videos during multiple user requests and sending data non-stop with embedded watermarks. This is accomplished by dividing the source video file into logical pieces of long and short segments. These short segments of the file can then be used for fast generation of watermarked frames while the long segments are being downloaded. The watermarked short segments are seamlessly appended to the long segments being downloaded to the client computer to provide them with a playable and watermarked file. The method enables embedding watermarks as often as needed to make manual extraction of watermarks difficult, and not so often that it will disturb the viewer of the video.

Each copy of a video will have a user-specific watermark added at a multitude of locations throughout the video. If a copy of the work is discovered having been illegally downloaded, then the user-specific watermark could be used to determine the source of the file. On the fly watermarking enables hassle free sales of videos that are marked in such a way as to give greater assurance that unauthorized copying can be traced back to the original purchaser. Since the watermark associates the user to the downloaded video, every streamed or downloaded movie will have a virtually undetectable and hard to remove watermark. The user will not be delayed in receiving video and the time it takes to watermark the video with a unique marking is relegated to virtually unnoticeable computer operations.

### BRIEF DESCRIPTION OF DRAWINGS

The drawings illustrate preferred embodiments of the method of the invention and the reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is a block diagram of raw video pre-watermarking operations.

FIG. 2 is a block diagram of watermarking operations.

FIG. 3 is a representation of the time lines involved in downloading a video.

FIG. 4 is a block diagram of preferred steps used in the video downloading and watermarking process.

FIG. 5 is a block diagram of the components in the apparatus used to implement a preferred embodiment of the method.

FIG. 6 is an example of a portable pixel matrix.

FIG. 7 is a representation of a paired sequential segment.

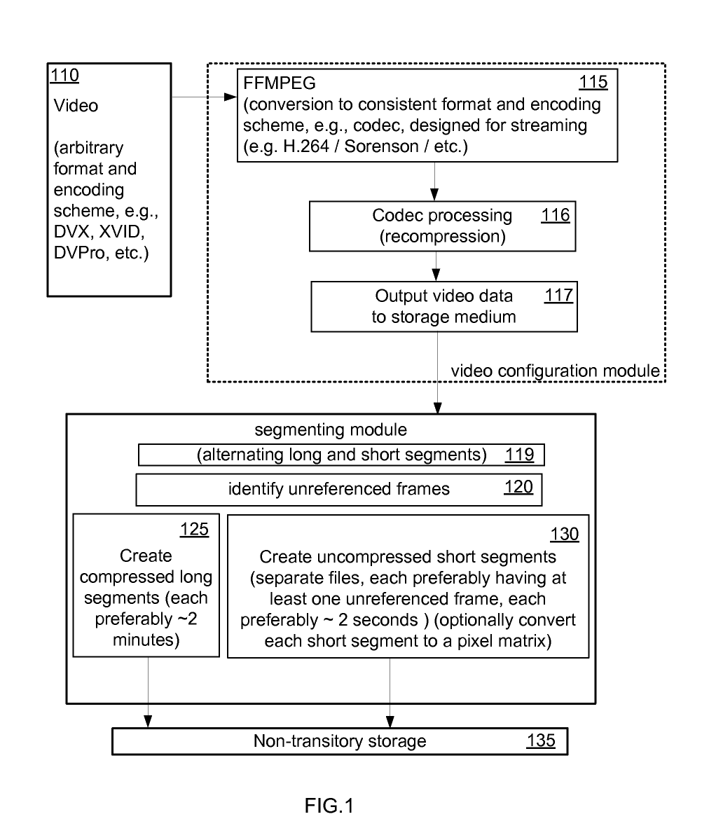

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention. For example, the steps in the method of the invention may be performed in any order that results applying a watermark to a video during download.

A preferred method is implemented on a computer (200) connected to a network (505). It applies of a watermark (216) to a video (110), also referred to as a video file. The process is best implemented on-the-fly, that is, while the video is being downloaded. So, the video (110) to be downloaded starts out in segments: long segments that are not watermarked and short segments that are watermarked during download. The video is seamlessly assembled during download with the watermarked short segments appended to the long segments.

The video (110) is the source video and is in one of many formats currently used, such as MP4, MPEG and Ogg. The video (110) may be encoded with an arbitrary codec designed for streaming, such as h.264 and Sorenson.

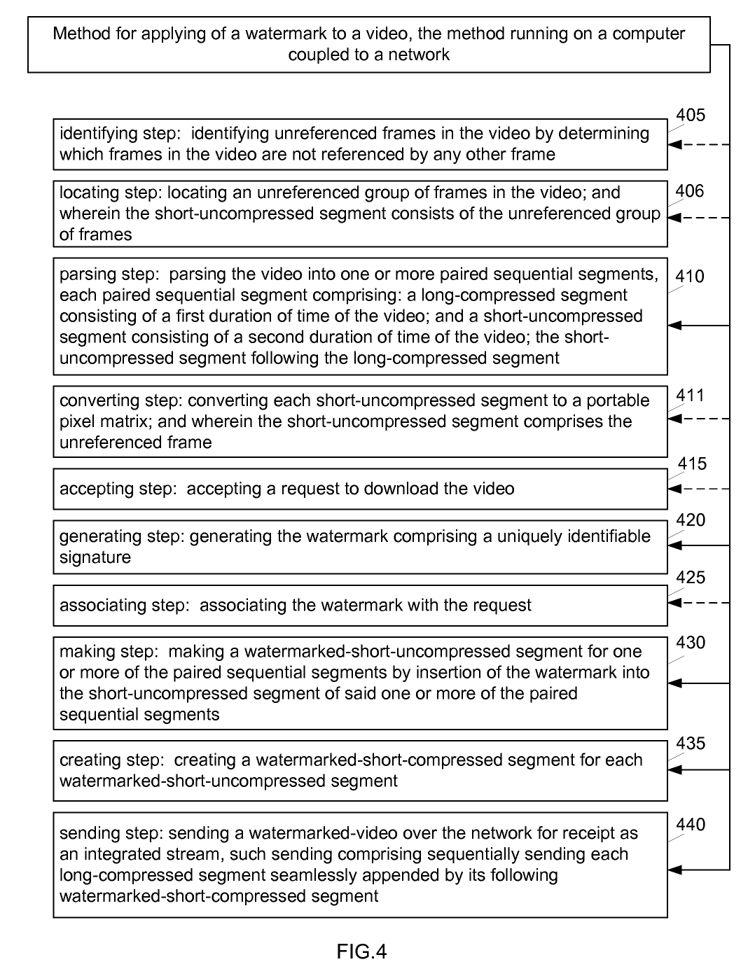

FIG. 4 shows this preferred method, which includes a parsing step (410), an accepting step (415), a generating step (420), an associating step (425), a making step (430), a creating step (435), and a sending step (440). An alternative method may include an identifying step (405).

The parsing step (410) includes parsing the video (110) into one or more paired sequential segments. Preferably there are many such paired sequential segments. However, there may be only one such paired sequential segment (705). Each paired sequential segment (705) in the plurality of paired sequential segments comprises: a long-compressed segment (315) consisting of a first duration of time of the video (110); and a short-uncompressed segment (706) consisting of a second duration of time of the video (110). The second duration of time is preferably, but not necessarily, shorter than the first duration. Thus, as used herein the term “short” is intended to be discriminator over the term “long” and also to reflect the preferred embodiment where the short segment is shorter in duration than the long segment The short-uncompressed segment (706) follows the long-compressed segment (315). Preferably, the first duration of time is about 2 minutes and the second duration of time is about 2 seconds.

The method may be performed by selecting arbitrary frames within the video (110) for watermarking. However, a preferred step includes an optional identifying step (405), which includes identifying unreferenced frames in the video (110) by determining which frames in the video (110) are not referenced by any other frame. This optional step is indicated by a dashed arrow in FIG. 4.

A video (110) consists of three kinds of frames; keyframes, P frames, and B frames. A keyframe contains enough information to rebuild the frame, while the P and B frames require information from neighboring frames. This means that watermarking or editing an arbitrary frame will cause modification to other frames that use the edited arbitrary frame. This problem might be solved by decoding all related frames and encoding them again, removing references to the edited frame. However, this is time consuming because multiple frames need to be edited.

Alternatively, a frame may be identified which is not referenced by other frames. In some codecs, frame sequences are separated by frames called IDR frames. In other codecs, frame sequences are separated by frames having another name. (e.g., in MPEG such frames are termed an “I-frames”). For simplicity, any such frame is referred to herein as an IDR frame.

Any frame after an IDR frame cannot reference a frame before the IDR frame in a decoded segment. So the segment would start with an IDR frame and end with an IDR frame, with no IDR frames in between. In encoding, display-order differs from decoding order. The last frame in some sequence with regards to display-order may not be the last in decoding order. Thus, if one edited the decoded frame just before the IDR frame (in decoding order), it would not affect any frames before it (because they can't reference it since they will have been decoded before decoding this frame), and any frames after it can't reference it because the frames are separated by an IDR frame. This is a simpler and preferable approach because there is no need to re-encode the video stream for deletion of references to the edited frame.

It is rare to find two nearby frames that are not referenced by some other frame. This is because the video compression programs typically use references between nearby frames to minimize size in bytes to store information about similar pictures. It is possible, however, to identify groups of frames and find that any one group of frames is not referenced by frames in other groups. So, for example, a group of frames bounded by IDR frames, including first IDR frame and excluding second IDR frame will be an unreferenced group of frames. For such group of frames, the watermark is added to each frame in such group so that all frames become watermarked and re-encoded. For this embodiment, the method includes a locating step (406), which is a step of locating an unreferenced group of frames in the video and, once located, the short-uncompressed segment consists of that unreferenced group of frames. This optional step is indicated by a dashed arrow in FIG. 4.

Optionally, the method includes a converting step (411), which is a step of converting each short-uncompressed segment (706) to a portable pixel matrix (610), also known as a portable pixel map. This optional step is indicated by a dashed arrow in FIG. 4. For example, such conversion may be implemented by having each short segment further segmented into separate files and converted to a pixel matrix. A pixel matrix is a lowest common denominator format (reference ppm definition format, updated Oct. 3, 2003, at website netpbm.sourceforge.net/doc/ppm.html).

Optionally, the method includes an accepting step (415), which is “accepting a request” (205) to download the video (110), which is caused by receipt of a request (204) accepted by the computer. This optional step is indicated by a dashed arrow in FIG. 4. When performed, the accepting step (415), results in a computer internal command of “requesting watermark of short segments” (206).

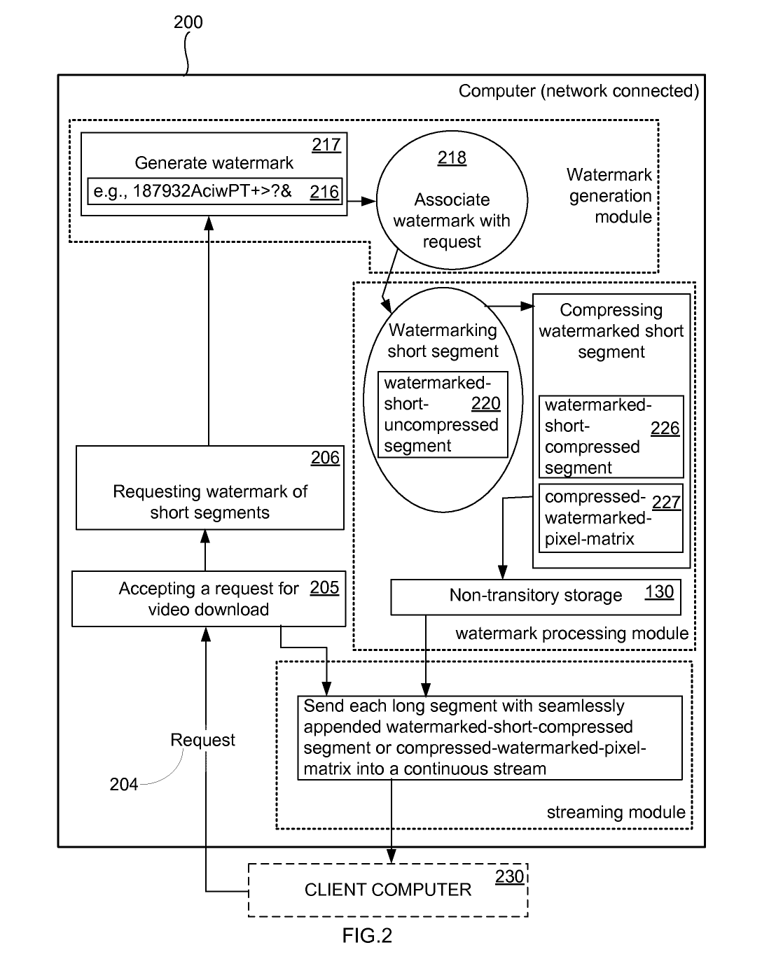

The generating step (420) includes generating the watermark (216) comprising a uniquely identifiable signature. The uniquely identifiable signature is preferably a randomly-generated alphanumeric string, but may be any other unique symbol such as a graphic image. An alphanumeric string is shown as “Generate watermark” (217) in FIG. 2, which shows a randomly-generated unique 16-chararacter string. Such a string may include any alphanumeric character.

When the accepting step (415) is included, then the method optionally includes an associating step (425), which is associating the watermark (216) with the request (204). This optional associating step (425) is indicated by a dashed arrow in FIG. 4. It is also illustrated in FIG. 2 as “Associate watermark with request” (218). Association of the uniquely identifiable signature with the requestor ties the watermark to a specific user download.

The making step (430) includes making a watermarked-short-uncompressed segment (220) for one or more of the paired sequential segments (705) by insertion of the watermark (216) into the short-uncompressed segment (706) of said one or more of the paired sequential segments. The use of “one or more” in this step is intentional because when there is more than one paired sequential segment, not all of the short-uncompressed segments (706) in paired sequential segments need be watermarked; though it would be preferably if all were watermarked. When the optional step of identifying unreferenced frames is performed, then the watermark (216) is inserted into the unreferenced frame of one or more short-uncompressed segments.

The creating step (435) includes creating a watermarked-short-compressed segment (226) for each watermarked-short-uncompressed segment (220).

The sending step (440) includes sending a watermarked-video (330) over the network (505) for receipt as an integrated stream. The sending step (440) is implemented by sequentially sending each long-compressed segment (315) seamlessly appended by the following watermarked-short-compressed segment (226).

Thus, in a preferred process, when a user requests a video file, a compressed portion of the video is downloaded. While the compressed portion of the video is being downloaded, the watermark is embedded on the uncompressed pixel matrix and it is compressed and merged into the compressed video. This process repeats until the entire video is downloaded. From the client's standpoint, he or she is receiving a solid compressed video file. In one or more embodiments, this watermark is put onto the file as it is being burned onto a DVD as part of the download. In another embodiment, this can be done while a video is streaming to a player on the client computer.

In another embodiment, as the frame to be watermarked is determined, it is noted where the frames to be watermarked are. Then as the video is being streamed, the frames to be watermarked are extracted, watermarked, and reinserted.

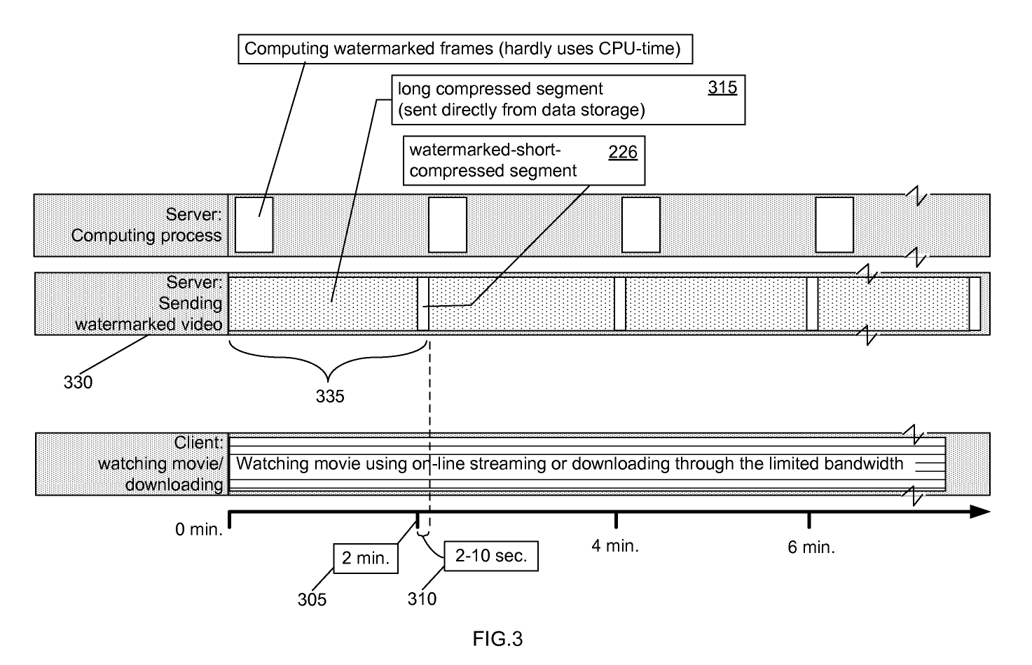

FIG. 3 illustrates the timeline of the downloading process, which is simply repeated in parallel when watermarking multiple video files for multiple download requests. For a single user, the server can send a small portion of the file (long-compressed-segment (315)) while a second module on the server creates the watermarked-short-compressed segment (226). By the time the compressed data is sent to the user, the uncompressed frames have been watermarked and compressed and can then be sent to the client. Because the time for computing the watermarked frames and compressing them is small, multiple users can be handled at the same time.

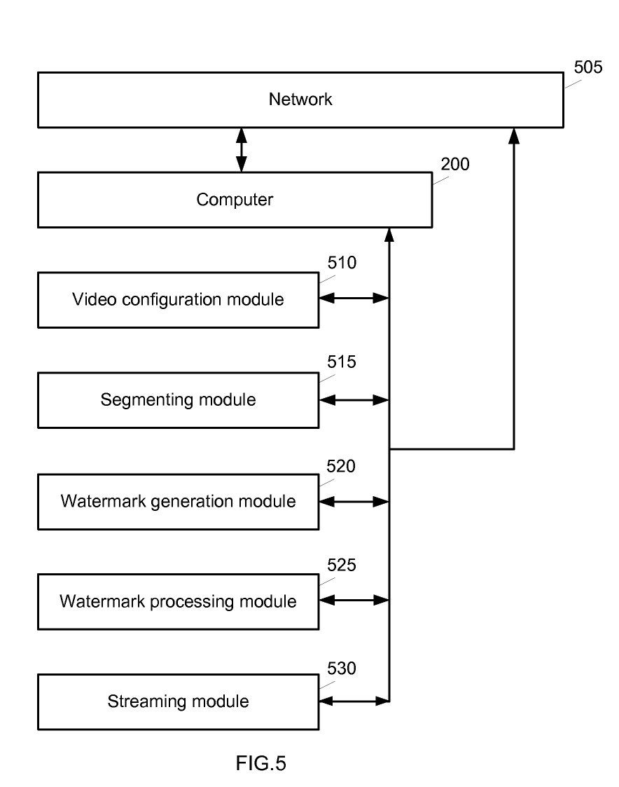

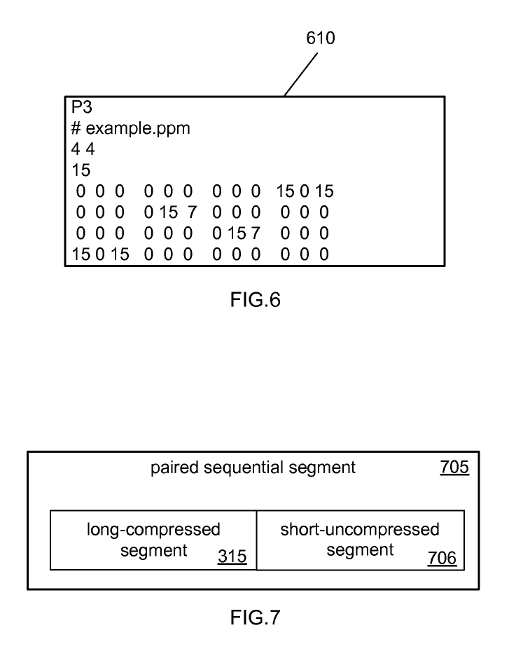

As shown in FIG. 5, the preferred computer for applying of the watermark (216) to a video (110) is coupled to a network (505), such as the Internet, for example to interact with users who may request a video (110). The computer may be a single device, but is preferably comprised of separate computers or modules programmed to, or operable to, perform the steps of the method. The modules also may be integrated in a single computer or be physically separate and connected to a central computer or server either directly or through the network (505). The modules include: a video configuration module (510), a segmenting module (515), a watermark generation module (520), a watermark processing module (525) and a streaming module (530).

One or more embodiments of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

The video configuration module (510) is operable to: accept a video (110) in an arbitrary format and encoding scheme and convert the video (110) to a consistent format and encoding scheme. In one or more embodiments, MP4 and h.264 is used as the consistent format and encoding scheme. In one or more embodiments, FFMPEG is used to convert arbitrary format and encoding scheme to MP4/h.264. FFMPEG is a free software project that produces libraries and programs for handling multimedia data. During the conversion to the arbitrary format, the video is re-compressed by the video configuration module (510).

The segmenting module (515) is operable to: identify unreferenced frames in the video (110) and segment the video (110) into one or more segments. These segments are alternating long and short segments (119), that is, a first long segment followed in sequence by a first short segment immediately followed by a second long segment which is followed in sequence by a second short segment, and so on. Each short segment preferably includes an unreferenced frame.

As shown in FIG. 2, the segmenting module (515) extracts each short-uncompressed segment (706) to a separate file. The segmenting module (515) may be further operable to convert each short segment to a portable pixel matrix (610). The temporal relationship between the segments is maintained in the non-transitory storage (130).

The segmenting module (515) stores single compressed files of long segments and single uncompressed short segments; the short segments optionally in uncompressed pixel matrices. Information about the proper order of segmentation may be stored in a data registry. In one or more embodiments, the data registry stores a pair of values, where the pair is a combination of the packet position of the required frame and the frame number. The package position is the offset in bytes from the beginning of the frame sequence. The frame number is the index of the frame in display order within the frame sequence. In one or more embodiments, the data registry can use any structured data to store it such as a database or structured text file.

The watermark generation module (520) is operable to: generate the watermark (216). It also optionally associates the watermark (216) with a specific download process.

The watermark processing module (525) is operable to: create a watermarked-short-compressed segment (226) by adding the watermark (216) to the unreferenced frame in one or more of the short segments; compress each watermarked-short-uncompressed segment (220) to create a watermarked-short-compressed segment (226); and store the watermarked-short-compressed segment (226) so as to be available for downloading.

The streaming module (530) is operable to seamlessly send each long-compressed-segment (315) and each compressed-watermarked-pixel-matrix (227) to a client computer (230) upon a request (204) to download the video (110). Upon completion of a compressed segment (335), the module repeats the process until the entire watermarked video (330) is downloaded.

An embodiment of the device consists of a collection of servers, each consisting of one or more computers connected to a network, each computer having one or more storage devices and one or more interactive input devices. These input devices may include but are not limited to a mouse, keyboard and webcam. The device is configured to connect with a client computer over a network. The client computer contains a program which will either play the compressed file or burn the compressed file onto a DVD.

The apparatus may alternatively be described as a non-transitory computer readable storage medium having stored thereon programming instructions that, when executed by a computer (200) coupled to a network (505), cause the computer (200) to perform a method for applying of a watermark (216) to a video (110) file. The non-transitory computer readable storage medium is an article of manufacture, such as network attached storage (NAS), read-only memory, random-access memory, CD-ROM disk, optical disk, a floppy drive, CD-R, CD-RW, DVD, flash drive, magnetic tapes, and other optical and non-optical data storage devices, and is not a transitory propagating signal per se.

The method performed by these programming instructions includes a step of segmenting the video (110) file into a plurality of alternating long compressed segments and short uncompressed segments. Each long compressed segment is preferably approximately 2 minutes of video (110), as is shown in FIG. 3 as “2 min.” (305). Each short uncompressed segment is preferably translates to about 2 to 10 seconds of watermarked-short-compressed segment (226), as shown in FIG. 3 as “2-10 sec.” (310). Each short uncompressed segment is at least one frame organized in a portable pixel matrix (610).

The method performed by these programming instructions optionally includes a step of “accepting a request” (205) to download the video (110) file.

The method performed by these programming instructions further includes a step of generating a watermark (216).

The method performed by these programming instructions further includes a step of placing the watermark (216) into the portable pixel matrix (610) of one or more of the short uncompressed segments to create a watermarked-pixel-matrix.

The method performed by these programming instructions further includes a step of compressing the short uncompressed segments, forming at least one compressed-watermarked-pixel-matrix (227).

The method performed by these programming instructions further includes a step of streaming seamlessly each long compressed segment and each compressed-watermarked-pixel-matrix (227) in response to the request (204).

With the above embodiments in mind, it should be understood that one or more embodiments of the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as creating, identifying, determining, or comparing.

Any of the operations described herein that form part of one or more embodiments of the invention are useful machine operations. One or more embodiments of the invention also relates to a device or an apparatus for performing these operations.

The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The programming modules and software subsystems described herein can be implemented using programming languages such as Flash, JAVA™, C++, C, C#, Visual Basic, JavaScript, PHP, XML, HTML etc., or a combination of programming languages. Commonly available protocols such as SOAP/HTTP may be used in implementing interfaces between programming modules. As would be known to those skilled in the art the components and functionality described above and elsewhere herein may be implemented on any desktop operating system such as different versions of MICROSOFT WINDOWS, APPLE MAC, UNIX/X-WINDOWS, LINUX, etc., executing in a virtualized or non-virtualized environment, using any programming language suitable for desktop software development.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application to the movie industry.

What is claimed is:

1. A method for applying of a watermark to a video, the video comprising frames, the method running on a computer coupled to a network, the method comprising the steps of:
parsing the video into one or more paired sequential segments, each paired sequential segment comprising:
a long-compressed segment consisting of a first duration of time of the video; and
a short-uncompressed segment consisting of a second duration of time of the video;
the short-uncompressed segment following the long-compressed segment;
generating the watermark comprising a uniquely identifiable signature;
making a watermarked-short-uncompressed segment for one or more of the paired sequential segments by insertion of the watermark into the short-uncompressed segment of said one or more of the paired sequential segments;
creating a watermarked-short-compressed segment for each watermarked-short-uncompressed segment; and
sending a watermarked-video over the network for receipt as an integrated stream, such sending comprising sequentially sending each long-compressed segment seamlessly appended by its following watermarked-short-compressed segment.

2. The method of claim 1, further comprising the step of identifying unreferenced frames in the video by determining which frames in the video are not referenced by any other frame.

3. The method of claim 2, further comprising the step of converting each short-uncompressed segment to a portable pixel matrix; and wherein the short-uncompressed segment comprises the unreferenced frame.

4. The method of claim 1, further comprising the step of identifying an unreferenced group of frames in the video; and wherein the short-uncompressed segment consists of the unreferenced group of frames.

5. The method of claim 1, wherein the first duration of time is about 2 minutes and the second duration of time is about 2 seconds.

6. A computer for applying of a watermark to a video file, the video file comprising frames, the computer coupled to a network, the computer comprising:
a video configuration module operable to:
accept a video in an arbitrary format and encoding scheme; and
convert the video to a consistent format and encoding scheme;
a segmenting module operable to:
identify unreferenced frames in the video;
segment the video into one or more segments, each of said segments comprising alternating long and short segments;
each said short segment comprising an unreferenced frame;
a watermark generation module operable to generate the watermark;
a watermark processing module operable to:
create a watermarked-short-uncompressed segment by adding the watermark to the unreferenced frame in one or more of the short segments;
compress each watermarked-short-uncompressed segment to create a watermarked-short-compressed segment; and
store the watermarked-short-compressed segment so as to be available for downloading; and
a streaming module operable to seamlessly send each long-compressed-segment and each watermarked-short-compressed segment to a client computer upon a request to download the video.

7. The computer of claim 6, wherein the segmenting module is further operable to convert each short segment to a portable pixel matrix.

8. A non-transitory computer readable storage medium having stored thereon programming instructions that, when executed by a computer coupled to a network, cause the computer to perform a method for applying of a watermark to a video file, the method comprising the steps of:
segmenting the video file into a plurality of alternating long compressed segments and short uncompressed segments, wherein each long compressed segment comprises approximately 2 minutes of video, and each short uncompressed segment comprising a frame organized in a portable pixel matrix;
generating a watermark;
placing the watermark into the portable pixel matrix of one or more of the short uncompressed segments to create a watermarked-pixel-matrix;
compressing the short uncompressed segments, forming at least one compressed-watermarked-pixel-matrix; and
streaming seamlessly each long compressed segment and each compressed-watermarked-pixel-matrix in response to the request.
